(19) United States
(12) Patent Application Publication
(10) Pub. No.: US 2024/0200238 A1
(43) Pub. Date: Jun. 20, 2024

(54) BELT STRAP

(71) Applicant: ZF AUTOMOTIVE GERMANY GMBH, Alfdorf (DE)

(72) Inventors: Viktorija MECNIKA, Schwabisch Gm¿nd (DE); Martina RAUSCH, Remshalden (DE); Michael SCHWAB, Markdorf (DE); Reiner GLASER, Salem (DE)

(21) Appl. No.: 18/557,066

(22) PCT Filed: Apr. 21, 2022
(86) PCT No.: PCT/EP2022/060559

§ 371 Date: Oct. 25, 2023

(30) Foreign Application Priority Data
Apr. 29, 2021 (DE) 10 2021 110 993.0

(51) Int. Cl. D03D 1/00; D03D 15/67

(52) U.S. Cl. CPC D03D 1/0005; D03D 15/67; D10B 2101/20; D10B 2401/18; D10B 2505/122

(57) ABSTRACT

The invention describes a webbing (10) for a seatbelt system of an automotive vehicle, comprising a webbing body (12), at least one electric conductor (14) and a flexible printed circuit board (16) disposed on the webbing body (12), wherein the at least one electric conductor (14) is electrically contacted by means of the flexible printed circuit board (16).

### TECHNICAL FIELD

The invention relates to a webbing for a seatbelt system of an automotive vehicle.

### BACKGROUND

A seatbelt system serves to restrain a vehicle occupant in the case of strong decelerations of the vehicle so that the vehicle occupant him-/herself is decelerated as smoothly as possible and is prevented from contacting objects inside the vehicle such as a steering wheel or an instrument panel.

Apart from the safety aspect, the webbing may also fulfill convenience functions such as a heating function. In addition, a sensor function may be integrated in the webbing.

In order to fulfill those functions, electrical contacting of the electric conductors provided in the webbing for this purpose is required.

Since the webbing is wound and unwound particularly frequently in the course of its life cycle, the electric contacting is subjected to high loads.

### SUMMARY

Therefore, it is an object of the invention to enable particularly reliable electric contacting of the electric conductors provided in the webbing which can withstand the loads occurring.

According to the invention, this object is achieved by a webbing for a seatbelt system of an automotive vehicle, comprising a webbing body, at least one electric conductor and a flexible printed circuit board disposed on the webbing body, wherein the at least one electric conductor is electrically contacted by means of the flexible printed circuit board.

The use of a flexible printed circuit board offers the advantage that the printed circuit board can deform with the webbing when the webbing is moving, for example when the webbing is wound onto a belt reel. In this way, the electric contacting is particularly reliable and the risk of the electric contacting being damaged or rupturing is reduced.

The flexible printed circuit board includes a plastic foil and a metal foil disposed on the plastic foil, for example. The metal foil serves as an electric conductor and for electrically contacting the electric conductor. The plastic foil acts as a substrate for the metal foil.

The use of foils is advantageous in that the flexible printed circuit board has a very small construction height.

The metal foil is a copper foil, for example.

The plastic foil is a polyimide, polyester or polyethylene naphthalate foil, for example. Polyimide is highly temperature-resistant and media-resistant and, thus, is particularly suited as a substrate for an electric conductor, specifically because the electric conductor may heat during operation. Also, when the electric conductor is connected to the metal foil, high temperatures may occur.

According to an embodiment, at least two electric conductors are provided, the two electric conductors being interconnected to be electrically conducting by the flexible printed circuit board. In this way, an electric circuit can be closed by the flexible printed circuit board.

The electric conductor is a wire, an electrically conducting thread or a strand, for example. Those conductors are particularly suited for use in a webbing, as they are flexible and, thus, the flexibility of the webbing is not restricted by the electric conductor.

Preferably, a further plastic foil is arranged on the copper foil, wherein the further plastic foil has a recess in the area of the metal foil used for contacting. The additional plastic foil can also be made of polyimide.

The additional plastic foil serves for covering and sealing, specifically along the edges of the printed circuit board and the metal foil, respectively. Accordingly, corrosion of the metal foil along the edges thereof and short-circuits between the electric conductors are avoided. Only the exposed surface of the metal foil can be provided with additional corrosion protection or with an additive for contacting. Moreover, the additional plastic foil has a heat-insulating effect.

According to an embodiment, the webbing has a woven webbing body including warp threads extending in the longitudinal direction and weft threads extending transversely to the warp threads, wherein the at least one electric conductor is woven as a warp thread or a weft thread into the webbing body. The electric conductor thus can be integrated particularly easily into the webbing body already during manufacture of the latter.

As an alternative, it is also conceivable that the electric conductor is stitched as a sewing thread onto the webbing body or is glued onto the webbing body.

The at least one electric conductor can be soldered or welded to the flexible printed circuit board. More precisely, the electric conductor can be soldered or welded to the metal foil. As an alternative, the at least one electric conductor can be soldered or welded to the contact faces (or free metal faces) of the printed circuit board. In this way, a reliable electric connection is established between the electric conductor and the flexible printed circuit board. Further fastening options are, for example, welding, (heat) staking or riveting.

Preferably, the flexible printed circuit board is glued onto the webbing body. The fixation of the printed circuit board on the webbing body is particularly simple in this way. For example, the printed circuit board is fixed to the webbing body by means of a double-sided adhesive tape.

According to an embodiment, the printed circuit board can be covered by a melted-on protective cap. The protective cap serves to stabilize the webbing body in the area of the printed circuit board. In other words, the webbing body is partially stiffened by the protective cap. In this way, the webbing body cannot be deformed or can be deformed less strongly in the area of the printed circuit board, thereby also the printed circuit board being not or only little deformed. Thus, the protective cap prevents the flexible printed circuit board from being excessively deformed and consequently contributes to an as long service life as possible of the printed circuit board and the electric contacting.

By melting on, the protective cap optimally adapts to the printed circuit board and to an electric conductor connected to the printed circuit board.

The protective cap also can be formed previously in a defined shape. The shape can be such that there is a space below the protective cap between the protective cap and the electric connection. Hence, the pressure when winding the webbing onto the belt retractor is so-to-speak buffered by the cavity.

The protective cap is formed by a melted-on plastic material, for example.

The melted-on protective cap adheres to the flexible printed circuit board already by melting. In addition, the protective cap can be fixed on the webbing body by means of ultrasonic welding.

The protective cap can be formed by a heated and thus cured textile instead of by melted-on plastic material. The textile is a felt material, for example.

Alternatively, or additionally, the flexible printed circuit board can be covered by a thermoplastic foil. The thermoplastic foil also serves as a protection for the flexible printed circuit board and the electric conductors in the area of the printed circuit board. Specifically, the thermoplastic foil prevents the electric conductors from getting rubbed off the printed circuit board or the printed circuit board from getting rubbed off the webbing body.

The thermoplastic foil in particular is a thermal transfer foil, i.e., the foil is applied to the webbing body by heat, with the foil connecting to the webbing body. In this way, no seams are required which would be visible at the rear of the webbing body and which might get rubbed off under adverse circumstances when the webbing moves over the deflection fitting.

Further, a padding may be disposed on the flexible printed circuit board. The padding is a compressible foil, for example, which is intended to protect the flexible printed circuit board against damage. Moreover, textile surface structures such as nonwovens or spacer fabrics can be used for this purpose, and also foams are suitable.

The padding can be disposed particularly below the thermoplastic foil.

The at least one electric conductor is, e.g., a heating conductor or a sensor, or the electric conductor is electrically connected to a sensor or to an electronic unit. The electronic unit may be a micro-electronic unit integrated in the electric conductor. Thus, different functions can be realized in the webbing.

### BRIEF DESCRIPTION OF THE DRAWINGS

Further advantages and features of the invention will be evident from the following description and from the attached drawings which are referred to, and wherein:

FIG. 1 schematically shows a webbing according to the invention,

FIG. 2 schematically shows the flexible printed circuit board of FIG. 1 in an exploded view,

FIG. 3 shows a further exploded view with a flexible printed circuit board, and

FIG. 4 shows a section across a flexible printed circuit board comprising a protective cap.

### DESCRIPTION

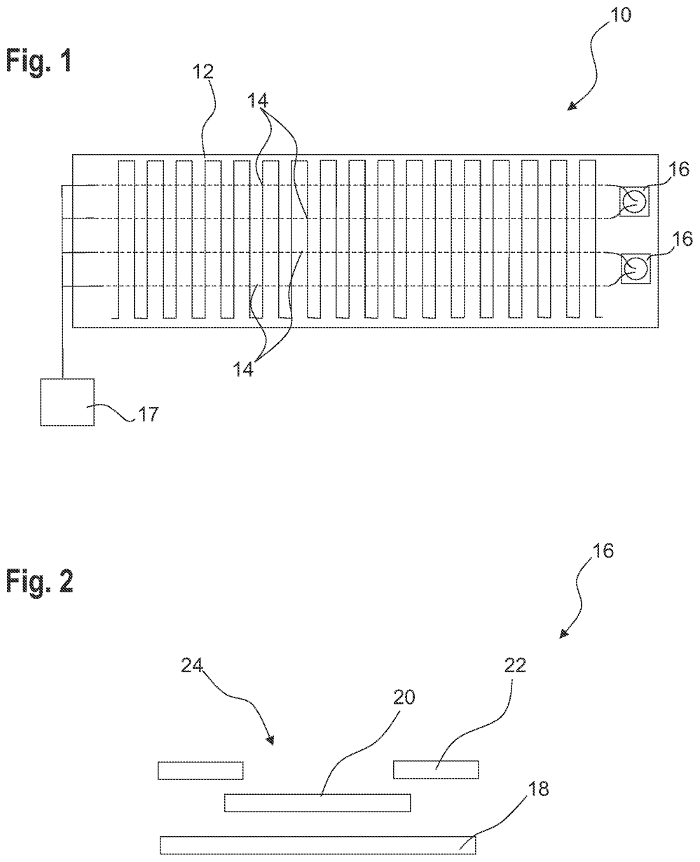

FIG. 1 schematically shows a webbing 10 for a seatbelt system of an automotive vehicle.

The webbing 10 has a webbing body 12. The webbing body 12 is usually woven and comprises warp threads extending in the longitudinal direction and weft threads extending transversely to the warp threads. In FIG. 1, only few threads are schematically shown for convenience.

The webbing 10 further comprises plural electric conductors 14.

The electric conductors 14 are formed, for example, by a wire, an electrically conducting thread or a strand.

For fixation, the electric conductors 14 can be woven as warp threads or as weft threads into the webbing body 12.

In the embodiment, the electric conductors 14 are woven into the webbing body 12 as warp threads.

As is schematically illustrated in FIG. 1, short sections of the electric conductors 14, more precisely the end sections of the electric conductors 14, are passed to a surface of the webbing body 12 so as to allow easier contacting of the electric conductors 14.

It is also conceivable to glue the electric conductors 14 or to stitch them as sewing thread.

The electric conductors 14 constitute a heating conductor, for example.

As an alternative, the electric conductors 14 can form a sensor or can be connected to a sensor, such as a temperature sensor, or an electronic unit which, for convenience, are not shown in the Figures.

According to the invention, the electric conductors 14 are contacted by means of a flexible printed circuit board 16 disposed on the webbing body 12.

Specifically, two respective electric conductors 14 are interconnected to be electrically conducting by the flexible printed circuit board 16, as will be explained in detail below.

In this way, a heating circuit can be closed, for example.

However, the electric conductors 14 are interconnected at one end only. At their opposite end, the electric conductors 14 are connected to a power source 17.

FIG. 2 schematically illustrates the flexible printed circuit board 16 shown in FIG. 1 in an exploded view.

The flexible printed circuit board 16 comprises a plastic foil 18, specifically a polyimide foil forming a substrate of the flexible printed circuit board 16.

A metal foil 20, specifically a copper foil, is disposed on the plastic foil 18. The metal foil 20 is used to establish an electric contact with the electric conductors 14.

The metal foil 20 covers only partly the plastic foil 18 formed as substrate. Accordingly, the metal foil 20 is arranged preferably in the middle of the plastic foil 18 when seen in a top view.

In addition, a further plastic foil 22 which may also be made of polyimide is disposed on the plastic foil 18 formed as a substrate and partially on the metal foil 20.

The additional plastic foil 22 has a recess 24, however, so that the metal foil 20 is accessible. More precisely, the additional plastic foil 22 covers an edge of the metal foil 20 and an edge of the plastic foil 18 (see also FIG. 4).

In order to electrically interconnect two electric conductors 14, the two electric conductors are welded or soldered with the metal foil 20, as illustrated in FIG. 1.

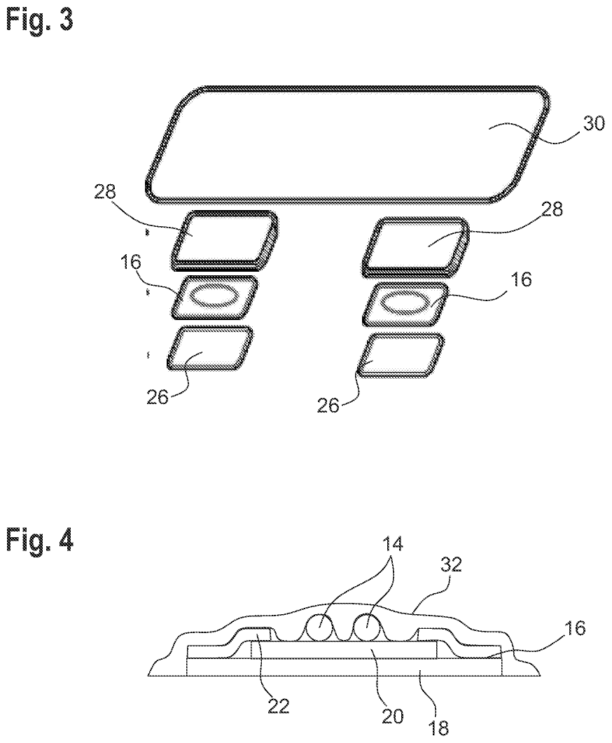

FIG. 3 schematically shows another exploded view with two flexible printed circuit boards 16 and further elements which may also be arranged on the webbing body 12.

On the one hand, FIG. 3 shows a double-sided adhesive tape 26 which is used to glue the flexible printed circuit boards 16 onto the webbing body 12.

Furthermore, a padding 28, which may be optionally provided, is arranged on the printed circuit boards 16.

The padding 28 is preferably glued on.

The padding 28 is a compressible foil or a textile fabric such as a nonwoven which is intended to protect the printed circuit boards 16 and the electric conductors 14 connected thereon against damage. Specifically, the padding 28 absorbs stress caused by pressure on the webbing 10.

Moreover, a thermoplastic foil 30 is optionally provided which also covers the printed circuit board 16 and the electric conductors 14 connected thereon. The thermoplastic foil 30 protects the printed circuit board 16 specifically against stress due to rubbing. In addition, the thermoplastic foil 30 prevents the padding 28 from detaching from the webbing 10.

In the illustrated embodiment, a thermoplastic foil 30 covers plural printed circuit boards 16. Accordingly, the assembly is facilitated. As an alternative, each printed circuit board 16 can be covered separately by a respective smaller thermoplastic foil. A further alternative is a continuous printed circuit board having plural contacting points and a continuous thermoplastic foil.

FIG. 4 shows an arrangement with a flexible printed circuit board 16 which can also be disposed on the webbing body 12.

The structure of the flexible printed circuit board 16 corresponds to the structure shown in FIG. 2.

Two electric conductors 14 which are interconnected by the flexible printed circuit board 16 are soldered or welded on the printed circuit board 16.

In the embodiment shown in FIG. 4, the printed circuit board 16 is covered by a melted-on protective cap 32.

The protective cap 32 was applied, for example, by placing a plastic plate onto the printed circuit board 16 and then heating it so that the plastic material starts to flow and adapts to the geometry of the printed circuit board 16, as illustrated in FIG. 4.

After the plastic material is cooled and cured again, the protective cap 32 is formed.

The cured plastic material and, resp., the protective cap 32 adheres to the printed circuit board 16.

The protective cap 32 stiffens the webbing 10 in the area of the printed circuit board 16 and, thus, prevents the webbing 10 and, resp., the printed circuit board 16 from being excessively bent so that despite the flexibility of the printed circuit board 16 damage of the contacting might occur.

The protective cap 32 may be formed of a curable textile instead of a plastic plate. The textile is flexible in its initial state, for example, and thus can adapt to the geometry of the printed circuit board 16. Optionally, pressure can be exerted on the textile so that the textile adapts even better to the geometry of the printed circuit board 16.

When the textile is adjacent to the printed circuit board 16, it is cured by heating and subsequent cooling, causing the protective cap 32 to be formed. As an alternative, the textile can be shaped in advance so that a space is created between the textile cap and the parts underneath it.

The cured textile also adheres to the printed circuit board 16.

It applies to both the cured textile and the protective cap 32 melted from a plastic plate that for better fixation to the webbing body 12 they can be fixed thereto by means of ultrasonic welding. For this purpose, the protective cap 32 is larger than the flexible printed circuit board 16, when seen in a top view, so that part of the protective cap 32 is directly adjacent to the webbing body 12.

When there is a protective cap 32, the padding 28 and the thermoplastic foil 30 can be omitted as the protective cap 32 already offers sufficient protection of the printed circuit board 16 against damage.

1-13. (canceled)

14. A webbing (10) for a seatbelt system of an automotive vehicle comprising a webbing body (12), at least one electric conductor (14) and a flexible printed circuit board (16) arranged on the webbing body (12), wherein the at least one electric conductor (14) is electrically contacted by means of the flexible printed circuit board (16).

15. The webbing (10) according to claim 14, wherein the flexible printed circuit board (16) includes a plastic foil (18) and a metal foil (20) arranged on the plastic foil (18).

16. The webbing (10) according to claim 14, wherein at least two electric conductors (14) are provided, the two electric conductors (14) being interconnected to be electrically conducting by the flexible printed circuit board (16).

17. The webbing (10) according to claim 14, wherein the electric conductor (14) is a wire, an electrically conducting thread or a strand.

18. The webbing (10) according to claim 14, wherein a further plastic foil (22) is disposed on the metal foil (20), the further plastic foil (22) having a recess (24) in the area of the metal foil (20).

19. The webbing (10) according to claim 14, wherein the webbing (10) has a woven webbing body (12) which includes warp threads extending in the longitudinal direction and weft threads extending transversely to the warp threads, the at least one electric conductor (14) being woven into the webbing body (12) as a warp thread or a weft thread.

20. The webbing (10) according to any claim 14, wherein the at least one electric conductor (14) is soldered, riveted or welded with the flexible printed circuit board (16).

21. The webbing (10) according to claim 14, wherein the flexible printed circuit board (16) is glued onto the webbing body (12).

22. The webbing (10) according to claim 14, wherein the printed circuit board (16) is covered by a melted-on protective cap (32).

23. The webbing (10) according to claim 14, wherein the printed circuit board (16) is covered by a protective cap (32) made of cured textile.

24. The webbing (10) according to claim 14, wherein the flexible printed circuit board (16) is covered by a thermoplastic foil (30).

25. The webbing (10) according to claim 14, wherein a padding (28) is disposed on the flexible printed circuit board (16).

26. The webbing (10) according to claim 14, wherein the electric conductor (14) is a heating conductor or a sensor, or in that the electric conductor (14) is electrically connected to a sensor or to an electronic unit.
